(19) United States
(12) Patent Application Publication
(10) Pub. No.: US 2006/0178498 A1
(43) Pub. Date: Aug. 10, 2006

(54) Water-dilutable alkyd resins, method for the production and the utilization thereof

(75) Inventors: Johann Billiani, Graz (AT); Gerhard Reidlinger, Graz (AT); Michael Gobec, Graz (AT); Ewald Zrin, Graz (AT)

Correspondence Address: CONNOLLY BOVE LODGE & HUTZ, LLP, P O BOX 2207, WILMINGTON, DE, 19899, US

(73) Assignee: Cytec Surface Specialties Austria Gmbh, Werndorf (AT)

(21) Appl. No.: 10/565,013

(22) PCT Filed: Jul. 13, 2004
(86) PCT No.: PCT/EP04/07720

§ 371 Date: Jan. 18, 2006

(30) Foreign Application Priority Data
Jul. 23, 2003 (AT) A1161/2003

(51) Int. Cl. C08G 63/49; C08L 67/00

(52) U.S. Cl. 528/295.5; 528/271

(57) ABSTRACT

The invention relates to water-dilutable alkyd resins ABC containing unsaturated fatty acids C, which are bonded by means of ester groups to graft copolymers AB containing hydroxyl groups, wherein said graft copolymers AB are obtained by grafting a mixture of vinyl monomers B onto alkyd resins A. The invention also relates to a method for the production of said resins and to the utilization thereof as binders for paints.

### FIELD OF THE INVENTION

The invention relates to water-dilutable alkyd resins. It also relates to a process for the preparation thereof and the use thereof, in particular for formulation of high-gloss top coat paints.

### BACKGROUND OF THE INVENTION

In AT-B 400 719, a process is disclosed where water-dilutable alkyd resins are prepared in a two-stage process, a copolymer of vinyl monomers and a mass fraction of from 25 to 50% of unsaturated fatty acids first being prepared. This copolymer is esterified with further unsaturated fatty acids, polyols and low-molar-mass dicarboxylic acids in a subsequent step to give an alkyd resin which can be emulsified in water.

The alkyd resins prepared in this way need to be improved with respect to their gloss. There are likewise problems when these alkyd resins are used for the formulation of paints, areas that have already been coated drying too rapidly which complicates adhesion of adjacent paint layers.

Providing a water-soluble alkyd resin which dries less rapidly and shows a better gloss in the paint films produced therefrom is therefore needed.

### SUMMARY OF THE INVENTION

The invention relates to water-dilutable alkyd resins ABC comprising units derived from unsaturated fatty acids C which are bonded via ester groups to graft polymers of vinyl monomers B on alkyd resins A. “Vinyl monomers” are meant to encompass, in the context of this invention, olefinically unsaturated monomers that can be copolymerised with styrene or methyl methacrylate in a polymerisation initiated by free radicals.

The invention also relates to a process for the preparation of water-dilutable alkyd resins ABC, wherein an alkyd resin A is initially prepared in the first step by polycondensation of dicarboxylic acids A1, aliphatic monocarboxylic acids A2 having from 2 to 40 carbon atoms, aliphatic linear, branched or cyclic alcohols A3 having at least two hydroxyl groups and optionally aliphatic mono- or diepoxides A4, which is then mixed in the second step with unsaturated fatty acids B2, and the mixture obtained in this way is reacted in the third step with vinyl monomers B selected from the group consisting of vinyl monomers B1 containing carboxyl groups, hydrophilic vinyl monomers B4 and further vinyl monomers B3 without hydroxyl or carboxyl groups, under conditions for free-radical polymerisation, graft polymers of the vinyl monomers B1, B3 and B4 with the alkyd resins A and the fatty acids B2 being formed, and these, with further unsaturated fatty acids C, are at least partly esterified with one another under condensation conditions and with splitting off of water, the fatty acids C preferably containing at least two olefinic double bonds per molecule, and these being conjugated in a particularly preferred embodiment.

Finally, the invention relates to a method of use of the water-dilutable alkyd resins ABC according to the invention for the preparation of paints of improved gloss.

### DETAILED DESCRIPTION OF THE PREFERRED EMBODIMENTS

The alkyd resins A contain units of dicarboxylic acids A1, aliphatic monocarboxylic acids A2 having from 2 to 40 carbon atoms, aliphatic linear, branched or cyclic alcohols A3 having at least two hydroxyl groups, and optionally aliphatic di- or monoepoxides A4. Their number-average molar mass Mₙ, is preferably 1,000 g/mol to 5,000 g/mol, and the weight-average molar mass is from approximately 2,000 g/mol to approximately 12,000 g/mol. Their acid number is preferably from 0 mg/g to 20 mg/g, particularly preferably from 1 mg/g to 10 mg/g, and their hydroxyl number is from 50 mg/g to 150 mg/g.

In this context, the dicarboxylic acids A1 are chosen from saturated or unsaturated linear, branched and cyclic aliphatic dicarboxylic acids having from 2 to 40 carbon atoms and from aromatic dicarboxylic acids having from 8 to 20 carbon atoms, or from anhydrides thereof if these exist. Malonic acid, succinic acid, maleic acid, adipic acid, 1,2-, 1,3- and 1,4-cyclohexanedicarboxylic acid, dimerised fatty acids and mixtures thereof, phthalic acid, terephthalic acid, isophthalic acid and tetrahydrophthalic acid and the anhydrides of the acids mentioned, if these exist, are preferred.

Suitable aliphatic monocarboxylic acids A2 are linear and branched aliphatic monocarboxylic acids, which optionally contain at least one double bond, such as acrylic acid, methacrylic acid and the higher unsaturated acids, such as myristic acid, palmitoleic acid, petroselic acid, petroselaidic acid, oleic acid, elaidic acid, linoleic acid, linolenic acid, alpha- and beta-eleostearic acid, gadoleic acid, arachidonic acid, erucic acid and clupanodonic acid, and saturated fatty acids, such as caproic acid, capric acid, 2-ethylhexanoic acid, lauric acid, myristic acid, palmitic acid, stearic acid, arachidic acid, behenic acid and lignoceric acid, in each case individually or in a mixture, in particular in the naturally occurring mixtures, such as linseed oil fatty acid, tall oil fatty acid, juvandol fatty acid or the fatty acid mixtures obtained from the native fats and oils, for example by saponification and isomerisation, such as conjuvandol fatty acid.

Suitable aliphatic alcohols A3 are di- and polyfunctional aliphatic linear, branched and cyclic alcohols having from 2 to 20 carbon atoms, such as e.g. ethylene glycol, 1,2-propylene glycol, 1,4-butanediol, 1,6-hexanediol, neopentyl glycol, glycerol, trimethylolpropane, pentaerythritol, ditrimethylolpropane and dipentaerythritol. Formals of tri- or polyhydric alcohols, such as trimethylolpropane monoformal or pentaerythritol monoformal, are likewise suitable.

The aliphatic mono- or diepoxides A4 optionally also used are preferably esters of glycidyl alcohol or ethers of glycidyl alcohol with monocarboxylic acids or monohydric alcohols having from 5 to 15 carbon atoms and esters of glycidyl alcohol with dicarboxylic acids or ethers with diphenols or dialcohols, such as adipic acid, succinic acid, bisphenol A or bisphenol F or butanediol, hexanediol or cyclohexanedimethanol.

The vinyl monomers B are selected from the group consisting of vinyl monomers B1 containing carboxyl groups, unsaturated fatty acids B2, hydrophilic vinyl monomers B4 having oligo- or polyalkylene glycol structures, C₂- and C₃-alkylene groups and mixtures thereof being preferred, and further vinyl monomers B3 without hydroxyl or carboxyl groups.

Suitable vinyl monomers B1 are olefinically unsaturated monocarboxylic acids, in particular acrylic and methacrylic acid. Suitable unsaturated fatty acids B2 are those mentioned above under A2, and suitable vinyl monomers B3 without functional groups apart from the olefinically unsaturated group are, in particular, styrene, vinyltoluene, the alkyl esters of acrylic or methacrylic acid, such as methyl, ethyl, butyl or 2-ethylhexyl (meth)acrylate, vinyl acetate and the vinyl esters of versatic acid. Suitable monomers B4 are, in particular, ethers of olefinically unsaturated alcohols, such as especially that of allyl alcohol with monoalkoxy-oligo- or -polyethylene glycol or monoalkoxy-oligo- or -polypropylene glycol or the monoalkoxy derivatives of mixed oligo- or polyglycols containing C₂- and C₃-alkylene units, as well as the half-esters of these monoalkoxy glycols with olefinically unsaturated carboxylic acids, such as acrylic and methacrylic acid. In this context, the degree of polymerisation of the oligo- or polyalkylene glycols is preferably from 2 to 20, the number of oxyethylene groups and the number of oxypropylene groups per molecule in each case preferably being from 0 to 10.

The unsaturated fatty acids C have from 6 to 40 carbon atoms and preferably at least two olefinic double bonds, which are preferably located so that at least two double bonds are conjugated with one another. Suitable fatty acids C are, in particular, the mixtures obtained from sunflower oil fatty acid or soya oil fatty acid by isomerisation, such as conjuvandol fatty acid, as well as the isomeric eleostearic acids.

The process according to the invention for the preparation of water-dilutable alkyd resins comprises, in the first step, the preparation of an alkyd resin A by polycondensation of dicarboxylic acids A1, aliphatic monocarboxylic acids A2 having from 2 to 40 carbon atoms, aliphatic linear, branched or cyclic alcohols A3 having at least two hydroxyl groups and optionally aliphatic di- or monoepoxides A4. In this context, the educts A1 to A3 are initially introduced into the reaction vessel and subjected to a condensation reaction, optionally with the addition of esterification catalysts based on organic compounds of transition metals or metals of main group four of the periodic table, the water of reaction being removed. If acids are employed in a stoichiometric excess here, the number of free carboxyl groups and therefore the acid number can be reduced by addition of aliphatic mono- or diepoxide compounds A4.

In the second step, the alkyd resins A prepared in this way are mixed with unsaturated fatty acids B2.

This mixture is then reacted in the third step with the further vinyl monomers chosen from vinyl monomers B1 containing carboxyl groups, hydrophilic vinyl monomers B4 and further vinyl monomers B3 without hydroxyl or carboxyl groups under free-radical polymerisation conditions, a grafted alkyd resin AB which contains carboxyl and hydroxyl groups being formed, as well as at least partly grafted fatty acids B2B. Grafting is preferably carried out by a procedure in which the alkyd resin A and the fatty acids B2 are dissolved in a solvent which is inert towards polymerisation and condensation reactions, namely aromatic or aliphatic hydrocarbons, such as xylene or mixtures of aromatics, ether-like solvents, such as glycol mono- or diethers, or ketones, the vinyl monomers are metered in or mixed with the solutions and grafting is started by addition of free radical initiators, such as peroxides, peroxy acids or azo compounds. According to the invention, it is preferable to add the free radical initiators in several portions.

In the third step, the graft copolymers AB are esterified with the at least partly grafted unsaturated fatty acids B2B and optionally further fatty acids C, the esterification preferably being carried out with azeotropic distillation of the water of reaction. After at least partial neutralisation of the acid groups in the esterified graft copolymer ABC, this is dispersed in water to a solids mass fraction of preferably 30% to 60%.

The graft polymer ABC formed preferably has a hydroxyl number of from 20 mg/g to 50 mg/g and an acid number of from 10 mg/g to 70 mg/g, preferably from 20 mg/g to 60 mg/g.

The aqueous dispersion obtained can be used in the formulation of alkyd resin paints which can be employed as clear paints, for example on wood, or as pigmented paints on substrates such as metals or plastics. The paints yield coatings of high gloss and low haze.

The examples which follow further explain the invention.

The acid number is defined according to DIN EN ISO 3682 as the quotient of that mass m_{KOH} of potassium hydroxide which is required to neutralise a sample to be analysed and the mass m_{B} of this sample (mass of the solid in the sample in the case of solutions or dispersions); its conventional unit is “mg/g”. The hydroxyl number is defined according to DIN EN ISO 4629 as the quotient of that mass m_{KOH} of potassium hydroxide which contains exactly as many hydroxyl groups as a sample to be analysed and the mass m_{B} of this sample (mass of the solid in the sample in the case of solutions or dispersions); its conventional unit is “mg/g”. The iodine number is defined according to DIN 53 241-1 as the quotient of that mass m_{I} of iodine which is added on to the olefinic double bonds, with decolouration, of a sample to be analysed and the mass m_{B} of this sample (mass of the solid in the sample in the case of solutions or dispersions); its conventional unit is “g/(100 g)” or “cg/g”. The quantity previously referred to as “limiting viscosity number”, called the “Staudinger index” J_{g} according to DIN 1342, Part 2.4, is the limiting value of the Staudinger function Jᵥ at decreasing concentration and shear stress, where Jᵥ is the relative change in viscosity based on the mass concentration β_{B}=M_{B}/V of the dissolved substance B (with the mass m_{B} of the substance in the volume V of the solution), that is to say Jᵥ=(ηᵣ−1)/β_{B}. In this formula, ηᵣ−1 denotes the relative change in viscosity, in accordance with ηᵣ−1=(η−ηₛ)/ηₛ. The relative viscosity ηᵣ is the quotient of the viscosity η of the solution analysed and the viscosity ηₛ of the pure solvent. (The physical meaning of the Staudinger index is that of a specific hydrodynamic volume of the solvated polymer coil at infinite dilution and in the state of rest.) The unit conventionally used for J is “cm³/g”; formerly often “dl/g”.

### EXAMPLES

### Example 1 (Comparison)

1.1 Alkyd Resin

240 g of soy bean oil fatty acid, 600 g of tall oil fatty acid having an iodine number of 150 cg/g, 285 g of conjuvandol fatty acid (having a mass fraction of approximately 50% of conjugated fatty acids), 536 g of trimethylolpropane and 462 g of hexahydrophthalic anhydride were charged into a 3 l glass reactor equipped with a stirrer, thermometer, water separator and reflux condenser and the mixture was homogenised. After the air had been displaced with nitrogen, the mixture was heated to 245° C., with constant stirring. The mixture was kept at this temperature until its acid number had fallen to below 10 mg/g (approximately 6 hours). After cooling to 180° C., 100 g of ®Cardura E 10 (glycidyl ester of versatic 10 acid, Resolution GmbH) were added in the course of thirty minutes and the reaction temperature was kept at 180° C. for a further hour. The acid number thereafter had fallen below 1 mg/g; the reaction was then interrupted by-cooling to room temperature. The resin (Staudinger index measured in chloroform: 6.2 cm³/g) was diluted to form a solution having a mass fraction of solids of 90% by addition of glycol monobutyl ether.

1.2 Grafted Alkyd Resin

387.7 g of the alkyd resin from Example 1.1 were introduced into a glass reactor equipped with a stirrer, dropping funnel, thermometer and reflux condenser. The resin was heated to 140° C. under a flow of nitrogen, and a mixture of 50.9 g of butyl methacrylate, 99.4 g of styrene, 47.7 g of methyl methacrylate, 43 g of methacrylic acid and 7.2 g of di-tert.-butyl peroxide was then metered in uniformly in the course of one hour. The mixture was subsequently reacted at this temperature for four further hours. It was then cooled to 90° C. and a mixture of 20.8 g of a solution of ammonia in water (mass fraction of NH₃ approximately 25%) and 114.6 g of desalinated water was added in the course of 30 minutes, under stirring. Thereafter, a further 730 g of water were added over the course of approximately 90 minutes, during which the temperature dropped to approximately 40° C.

### Example 2

2.1 Alkyd Resin A

240 g of soy bean oil fatty acid, 100 g of conjuvandol fatty acid (having a mass fraction of approximately 50% of conjugated fatty acids), 536 g of trimethylolpropane and 462 g of hexahydrophthalic anhydride were charged into a 2 l glass reactor equipped with a stirrer, thermometer, water separator and reflux condenser and the mixture was homogenised. After the air had been displaced with nitrogen, the mixture was heated to 245° C., with constant stirring. The mixture was kept at this temperature until its acid number had fallen to below 10 mg/g (approximately 4 hours). After cooling to 180° C., 100 g of ®Cardura E 10 (glycidyl ester of versatic 10 acid, Resolution GmbH) were added in the course of 30 minutes and the reaction temperature was kept at 180° C. for one further hour. The acid number thereafter had fallen below 1 mg/g; the reaction was then interrupted by cooling to room temperature. The resin was diluted to form a solution having a mass fraction of solids of 90% by addition of xylene.

2.2 Grafted and Esterified Alkyd Resin ABC

229 g of the alkyd resin from Example 2.1 and 96 g of tall oil fatty acid having an iodine number of 150 cg/g were introduced into a glass reactor with a stirrer, dropping funnel, reflux condenser, water separator and thermometer; the resin was heated to 140° C. under a flow of nitrogen. A mixture of 50.9 g of n-butyl methacrylate, 99.4 g of styrene, 47.7 g of methyl methacrylate, 43 g of methacrylic acid and 7.2 g of di-tert.-butyl peroxide was metered in uniformly at this temperature in the course of six hours. The reaction was continued at this temperature for four further hours; thereafter 29.6 g of conjuvandol fatty acid were added, the mixture was heated to 175° C. and the solvent xylene was distilled off under reduced pressure. Esterification was continued at the same temperature until a Staudinger index of 12 g/cm³ (measured in chloroform) was reached. 57.6 g of glycol monobutyl ether were subsequently added and the mixture was cooled to 90° C. A mixture of 20.8 g of a solution of ammonia in water (mass fraction of NH₃ approximately 25%) and 114.6 g of desalinated water was added in the course of 30 minutes, under stirring. Thereafter, a further 730 g of water were added over the course of approximately 90 minutes, during which the temperature dropped to approximately 40° C.

### Example 3

3.1 Alkyd Resin A

240 g of soy bean oil fatty acid, 100 g of conjuvandol fatty acid (having a mass fraction of approximately 50% of conjugated fatty acids), 536 g of trimethylolpropane and 462 g of hexahydrophthalic anhydride were charged in a 2 l glass reactor equipped with a stirrer, thermometer, water separator and reflux condenser and the mixture was homogenised. After the air had been displaced with nitrogen, the mixture was heated to 245° C., with constant stirring. The mixture was kept at this temperature until its acid number had fallen to below 10 mg/g (approximately 4 hours) and the reaction was then interrupted by cooling to room temperature. The resin was diluted to form a solution having a mass fraction of solids of 90% by addition of xylene.

3.2 Grafted and Esterified Alkyd Resin ABC

229 g of the alkyd resin from Example 3.1 and 96 g of tall oil fatty acid having an iodine number of 150 cg/g were charged into a glass reactor equipped with a stirrer, dropping funnel, reflux condenser, water separator and thermometer; the resin was heated to 140° C. under a flow of nitrogen. A mixture of 50.9 g of n-butyl methacrylate, 99.4 g of styrene, 47.7 g of methyl methacrylate, 43 g of methacrylic acid and 7.2 g of di-tert.-butyl peroxide was metered in uniformly at this temperature in the course of six hours. The reaction was continued at this temperature for four further hours; thereafter 29.6 g of conjuvandol fatty acid were added, the mixture was heated to 175° C. and the solvent xylene was distilled off under reduced pressure. Esterification was continued at the same temperature until a Staudinger index of 12 g/cm³ (measured in chloroform) was reached. 57.6 g of glycol monobutyl ether were subsequently added and the mixture was cooled to 90° C. A mixture of 20.8 g of a solution of ammonia in water (mass fraction of NH₃ approximately 25%) and 114.6 g of desalinated water was added in the course of 30 minutes, under stirring. Thereafter, a further 730 g of water were added over the course of approximately 90 minutes, during which the temperature dropped to approximately 40° C.

### Examples 4 to 6

The alkyd resins A of Examples 4.1 to 6.1 were prepared in analogy to Example 3, the starting substances listed in the following table being employed.

TABLE 1
Alkyd resins A (composition of the reaction
mixture)

| Example | | 4.1 | 5.1 | 6.1 |
|---|---|---|---|---|
| Soy bean oil fatty acid | g | 240 | 240 | 260 |
| Conjuvandol fatty acid | g | | 22 | 20 |
| Trimethylolpropane | g | 536 | 120 | |
| Pentaerythritol | g | | | 115 |
| Hexahydrophthalic anhydride | g | 462 | | |
| Isophthalic acid | g | | 117 | |
| Phthalic anhydride | g | | | 91 |
| Benzoic acid | g | | 60 | |
| Water separated by distillation | g | −66.4 | −27.3 | −28.6 |
| Xylene | g | 130.5 | 134.0 | 51.0 |
| Acid number of the alkyd resin A | mg/g | 6.7 | 14.1 | 3.1 |
| Staudinger index of the alkyd resin A | cm³/g | 5.3 | 6.2 | 6.1 |

The alkyd resins A prepared in this way (solutions having a mass fraction of solids of 90 g of the resin in 100 g of the solution) were then reacted with the monomers mentioned in Table 2 under conditions for a free-radical polymerisation. During this procedure, the alkyd resins A were first mixed with an additional amount of a fatty acid B2 and the mixture was heated to 140° C. under a nitrogen blanket. A mixture of the said monomers B with the initiator was then added dropwise over a period of 360 minutes. When the addition had ended, the temperature was maintained for approximately 250 minutes more; thereafter the further fatty acids C were admixed, the mixture was heated to approximately 175° C. and the water of reaction was separated by azeotropic distillation. Esterification was continued until a Staudinger index of the alkyd resin ABC of approximately 12 cm³/g was reached. The solvent xylene was then removed by distillation under reduced pressure and, after cooling, the product was adjusted to a solids mass fraction of approximately 38% by addition of butyl glycol, neutralising agent and two portions of water.

TABLE 2
Composition of the emulsions of the condensed
and grafted alkyd resins

| Example | | 4.2 | 5.2 | 6.2 |
|---|---|---|---|---|
| Alkyd resin A of Example | | 4.1 | 5.1 | 6.1 |
| Mass of the alkyd resin | g | 208.2 | 504.0 | 198.0 |
| solution (90%) | | | | |
| Linseed oil fatty acid | g | | 72 | |
| Tall oil fatty acid | g | 96 | | 71 |
| Polyethylene glycol monoallyl | g | | | 3.0 |
| ether ( ® Maxemul 5010) | | | | |
| n-Butyl methacrylate | g | 50.9 | 53.0 | 52.0 |
| Styrene | g | 99.4 | 11.0 | 20.0 |
| Methyl methacrylate | g | 47.7 | | |
| Methacrylic acid | g | 43.0 | 36.0 | 25.0 |
| ® Bisomer PPA6S (methacrylic | g | | 3.0 | |
| acid ester of | | | | |
| polypropylene glycol) | | | | |
| Di-tert.-butyl peroxide | g | 7.2 | 5.0 | 7.0 |
| Conjuvandol fatty acid | g | 45.6 | | |
| Ricinene fatty acid | g | | 55 | |
| Water separated by azeotropic | g | −9.6 | −9.1 | −4.7 |
| distillation | | | | |
| Xylene distillate | g | −20.8 | −151.4 | −19.8 |
| Butyl glycol | g | 57.6 | 85.0 | 40.0 |
| Water | g | 114.6 | 716.0 | 300.0 |
| Aqueous ammonia solution (25%) | g | 20.8 | 23.0 | 17.0 |
| Acid number of the alkyd | mg/g | 53 | 53 | 47 |
| resin ABC | | | | |
| Staudinger index measured | cm³/g | 11.9 | 12.1 | 13.1 |
| in chloroform | | | | |
| mass fraction of solids* | % | 38.6 | 37.2 | 38.0 |
| Dynamic viscosity of the solution | mPa · s | 530 | 4,500 | 2,500 |
| pH (10% strength solution | | 8.7 | 7.0 | 8.6 |
| in water) | | | | |
| Mass fraction of polymer B in | % | 42 | 18 | 27 |
| the alkyd resin ABC | | | | |
| Acid number, based on the | mg/g | 113 | 219 | 152 |
| mass of polymer B | | | | |
| Mass fraction of the fatty acids in | % | 34 | 30 | 54 |
| the alkyd resin ABC | | | | |

*mass fraction of solids measured via the dry residue in accordance with DIN 55 671.

Paints were prepared from the alkyd resin dispersions according to Examples 1 to 4 in accordance with the following recipes:

TABLE 3
Paint recipes

| Water-dilutable alkyd | | | | | |
|---|---|---|---|---|---|
| resin of Example | | 1 | 2 | 3 | 4 |
| Mass of the dispersion | g | 68.2 | 67.4 | 68.2 | 68.4 |
| Thickener ( ® Optiflo H 600)^{a} | g | 0.5 | 0.5 | 0.5 | 0.5 |
| Siccative combination | g | 0.2 | 0.2 | 0.2 | 0.2 |
| (Cobalt ® Aqua 7)^{b} | | | | | |
| Anti-skinning agent | g | 0.3 | 0.3 | 0.3 | 0.3 |
| (butanone oxime) | | | | | |
| Pigment paste^{c} | g | 29.4 | 29.4 | 29.4 | 29.4 |
| Completely desalinated water | g | 7 | 12 | 12 | 12 |
| Dynamic viscosity (10⁴ s⁻¹, 23° C.) | mPa · s | 115 | 95 | 100 | 90 |
| pH (DIN ISO 976) | | 8.8 | 8.8 | 8.8 | 8.8 |
| Non-tacky after | min | 30 | 30 | 30 | 60 |
| Through-drying after 24 hours^{d} | | 20 | 20 | 20 | 20 |
| Gloss 20° (BYK Gardner) | | 18 | 86 | 87 | 89 |
| Gloss 60° | | 61 | 92 | 94 | 96 |
| (in accordance with DIN 67 530) | | | | | |
| Haze (BYK Gardner, | | 103 | 21 | 30 | 24 |
| ASTM E 430) | | | | | |

^{a}Süd-Chemie AG, Moosburg
^{b}Borchers GmbH, Monheim
^{c}Pigment paste: composition see Table 4
^{d}Through drying: determined by performing a scratch trial with the fingernail 24 hours after application of the paint to a glass plate; “10” means “no attack” = good; “50” means “film smeary, can easily be removed from the plate” = poor

1. Water-dilutable alkyd resins ABC containing unsaturated fatty acids C which are bonded via ester groups to graft copolymers AB containing hydroxyl groups, these graft copolymers AB being obtained by grafting a mixture of vinyl monomers B on to alkyd resins A.

2. The water-dilutable alkyd resins ABC of claim 1, characterised in that the mass fraction of the fatty acids C in the alkyd resins ABC is from 20% to 60%.

3. The water-dilutable alkyd resins ABC of claim 1, characterised in that the mixture of the vinyl monomers B contains a mass fraction of from 8% to 30% of monomers B1 containing carboxyl groups.

4. The water-dilutable alkyd resins ABC of claim 1, characterised in that it contains a mass fraction of from 10% to 60% of unsaturated fatty acids B2, based on the mass of the mixture of the vinyl monomers B.

5. The water-dilutable alkyd resins ABC of claim 1, characterised in that the mixture of the vinyl monomers contains a mass fraction of from 0% to 10% of olefinically unsaturated compounds B4 selected from the group consisting of ethers of olefinically unsaturated alcohols with monoalkoxy-oligo- or -polyethylene glycol or monoalkoxy-oligo- or -polypropylene glycol, the monoalkoxy derivatives of mixed oligo- or polyglycols containing C₂- and C₃-alkylene units, and the half-esters of these monoalkoxy glycols with olefinically unsaturated carboxylic acids.

6. The water-dilutable alkyd resins ABC of claim 1, characterised in that they have a hydroxyl number of from 5 mg/g to 150 mg/g and a Staudinger index of from 8 cm³/g to 15 cm³/g, measured in chloroform.

7. A process for the preparation of water-dilutable alkyd resins ABC according to claim 1, containing the steps of
polycondensation of dicarboxylic acids A1, aliphatic monocarboxylic acids A2, aliphatic linear, branched or cyclic alcohols A3 having at least two hydroxyl groups and optionally aliphatic di- or monoepoxides A4 to produce alkyd resins A
admixing of unsaturated fatty acids B2
grafting of the mixture of the alkyd resins A and the fatty acids B2 with a mixture of vinyl monomers B comprising vinyl monomers B1 containing carboxyl groups and vinyl monomers B3 that contain neither hydroxyl groups nor acid groups, in the presence of free radical initiators to produce a graft copolymer AB containing carboxyl groups,
condensation of the graft copolymer AB with unsaturated fatty acids C under esterification conditions to produce a water-dilutable alkyd resin ABC.

8. The process of claim 7, characterised in that the mixture of the vinyl monomers additionally contains olefinically unsaturated monomers B4 according to claim 5.

9. A method of use of the water-dilutable alkyd resins ABC of claim 1 for formulation of paints, comprising the steps of neutralisation of the alkyd resins ABC, during which from 30% up to 100% of the acid groups of the alkyd resins ABC are neutralised, and emulsifying of the neutralised alkyd resins ABC in water.

10. The method of use of claim 9 for formulation of pigmented paints, characterised in that the pigments are dispersed in the alkyd resins ABC before neutralisation.
